(19) United States
(12) Patent Application Publication
(10) Pub. No.: US 2024/0119795 A1
(43) Pub. Date: Apr. 11, 2024

(54) GAMING MACHINE AND METHOD WITH ENHANCED MOVEMENT BONUS

(71) Applicant: Everi Games Inc., Austin, TX (US)

(72) Inventors: Juan Mariscal, Las Vegas, NV (US); Cydny Bloem Audia, Chicago, IL (US); Darren Hale, Los Angeles, CA (US); Cara Cioffari, Las Vegas, NV (US); Jason Chan, Chicago, IL (US); Andrew Durre, Mt. Prospect, IL (US)

(73) Assignee: Everi Games Inc., Austin, TX (US)

(21) Appl. No.: 17/962,384

(22) Filed: Oct. 7, 2022

(51) Int. Cl. G07F 17/32; G07F 17/34

(52) U.S. Cl. CPC G07F 17/3258; G07F 17/3213; G07F 17/3262; G07F 17/34

(57) ABSTRACT

A gaming machine, system, method, and program product provide a slot machine game with a movement game board bonus game. Responsive to a trigger pattern in a base game result, a prize board is displayed including a number of symbol locations containing symbols indicating prizes, and a current position indicator indicating a current location on the board. A number of selectable items are provided from which the player may select. Responsive to selections, one of a movement indicator with an associated movement direction, or a prize collector indicator are revealed. For a movement indicator, the current position indicator moves to an adjacent one of the symbols on the prize board in a direction shown by the movement indicator. For a prize collector indicator, the method includes awarding a prize associated with the prize level of the current position indicator.

### FIELD OF THE INVENTION

This invention relates to gaming systems and to gaming machines, and in particular gaming machines including games with bonus features including moving on a game board.

### BACKGROUND

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Many video-based gaming machines have three or five spinning reels that may be stopped to display a matrix of game symbols. The symbols displayed on the stopped reels correlate to a result of the game. A typical reel-based slot machine game includes a number of paylines defined through symbol locations on a reel. Bonus features for such games may be shown on mechanical or simulated wheels, which conduct a free spin to select a bonus prize or a jackpot prize.

A popular use of wagering games is simulated wagering in which money is never involved, and instead points or simulated currency are wagered. Many “virtual casino” websites and smartphone apps employ such a scheme in addition to or instead of money wagering. Numerous variations are used to improve the prize variability and player enjoyment associated with such payline games. However, game manufacturers are continuously pressed to develop new game presentations, formats, and game graphics in an attempt to provide high entertainment value for players and thereby attract and keep players.

### SUMMARY OF THE INVENTION

The present invention encompasses methods for controlling games, gaming machines, and computer programs that provide enhanced gaming features including a movement board game presented as a bonus game.

According to one aspect of the invention a method is provided for operating a gaming machine. Responsive to a play input, a base result representation is shown a matrix of symbol locations. Responsive to a trigger pattern formed in the base result representation, a prize board is displayed including a number of symbol locations containing respective symbols indicating respective prize levels and a current position indicator indicating a current location among the symbol locations. In a second display area a number of selectable items are displayed. A player is allowed to make selections from the number of selectable items. Responsive to a player selection of a one of the selectable items, the method includes revealing one of a movement indicator with an associated movement direction, or a prize collector indicator. Responsive to revealing a movement indicator, the method includes causing the current position indicator to move to an adjacent one of the symbols on the prize board in a direction shown by the movement indicator. Responsive to revealing a prize collector indicator, the method includes awarding a prize associated with the prize level of the current position indicator.

Another aspect of the invention is a gaming system that includes one or more gaming servers, and a group of electronic gaming machines connected to the servers by a network, programmed to provide one of more of the methods described herein. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 through FIG. 15 depict a sequence of game screens showing a bonus game feature including movement on a game board according to some embodiments.

FIG. 16 shows a flowchart of a process for operating a gaming machine according to some embodiments.

FIG. 17 shows a block diagram of software and data structures performing operations employed in operating a bonus game according to some embodiments.

FIG. 18 shows a gaming machine that may be used to implement feature games according to some embodiments.

FIG. 19 shows a hardware and logical block diagram of gaming machine according to some embodiments.

FIG. 20 shows a block diagram of a network system including multiple servers and gaming machines.

### DETAILED DESCRIPTION OF EXAMPLE EMBODIMENTS

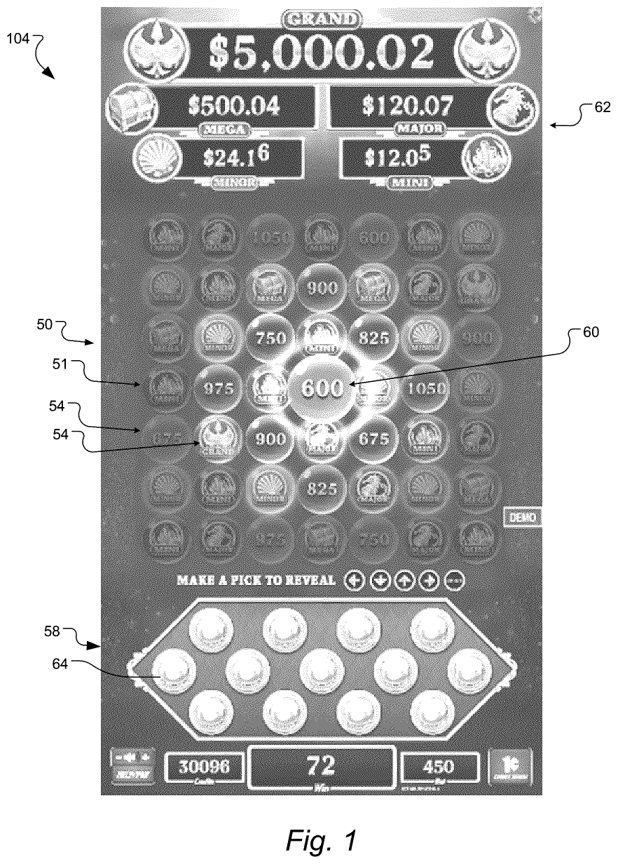

FIG. 1 is a game screen diagram illustrating a bonus base game mode showing a primary display 104 to illustrate an example slot machine display arrangement on which conduct of a bonus game is presented in a first display area 50, typically found on the primary display. A second display area 58 is also present on the display 104. In versions including multiple displays, second display area 58 may be located on a lower display and first display area 50 on an upper display.

The first display area 50 in the depicted bonus mode presents a board game on which a current location is moved. In this embodiment, first display area includes a prize board 51 including a number of symbol locations 54 containing respective symbols indicating respective prize levels. A current position indicator 60 indicates a current location among symbol locations 54. In this embodiment, the symbols in symbol locations 54 include a set of jackpot award symbols associated with a set of respective jackpot awards, and a set of numerical symbols associated with respective prize values. The current value of the jackpot awards is shown in jackpot indicators 62, and is updated as the values change due to player contributions or awards. In this embodiment, the jackpot awards include a “GRAND” prize, a “MEGA” prize, a “MAJOR” prize, a “MINOR” prize, and a “MINI” prize. Other embodiments may instead include fixed bonus prizes presented in the same manner.

In second display area 58 are displayed a number of selectable items 64, from which a player is allowed to select to conduct the board game bonus feature as further described below.

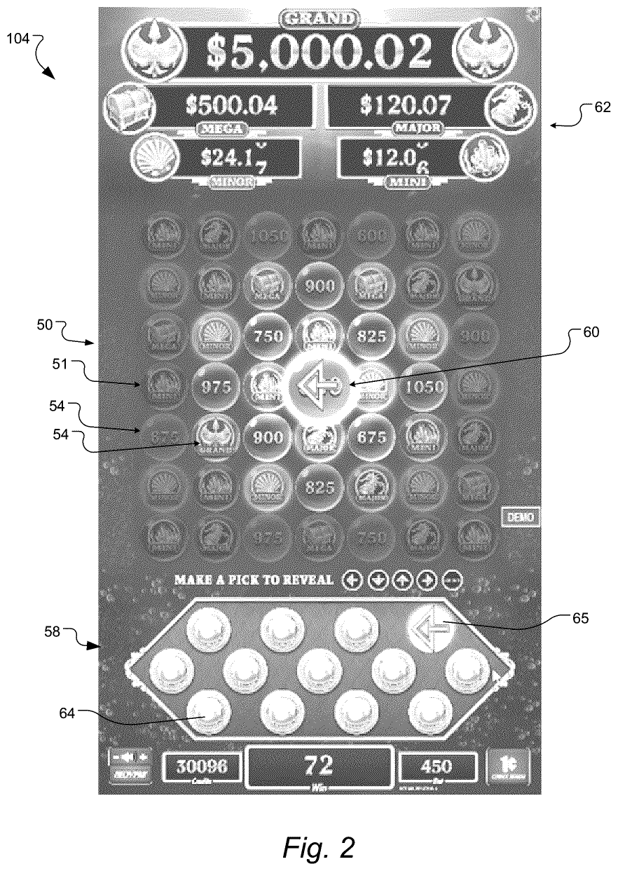

FIG. 2 through FIG. 15 depict a sequence of game screens showing progress of example play scenario through the movement board game of FIG. 1.

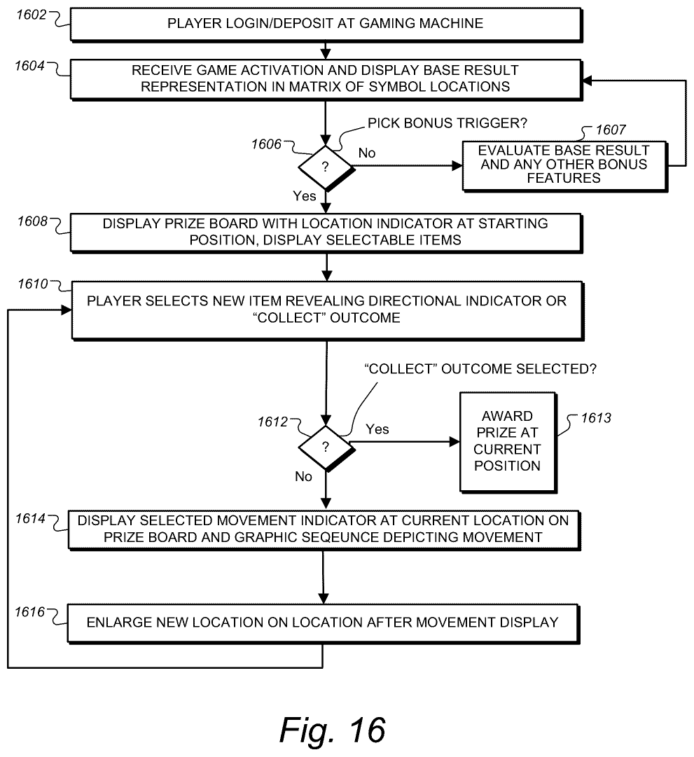

FIG. 16 shows a flowchart of a process for operating a gaming machine according to some embodiments. The process will be described with reference to FIG. 16 and the game screen diagrams of FIGS. 1-15. Generally, the process is performed responsive to play activation inputs entered through a player input device of the gaming machine and under control of a processing system of the gaming machine executing game presentation program code. The process beings at block 1602 where a player logs into a gaming machine or makes a credit deposit to establish a credit balance at the gaming machine. Where credit deposits are used, they include receiving the player deposit through a credit input device such as a bill/voucher acceptor, and in response activating a credit meter value that establishes a player credit balance. Other non-financial points may be used in which points are risked and awarded in the game having no financial value, in some embodiments.

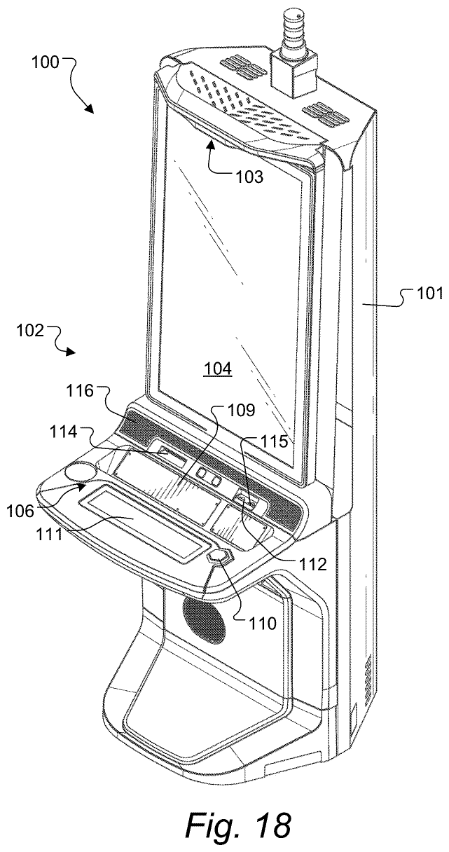

To begin a game play, at block 1604 the process receives a game activation, which may activate financial wager with money value credits or an activation of a game play for a game based on non-financial points with no financial value. The activation is made on a player input device at the gaming machine, which typically consists of some input from the player to set the amount to be wagered from their credit amount on the machine and activate a game round using the set wager amount. The wager amount may also be carried over from previous game rounds by simply starting the game with the previous wager amount set. This typically happens through a ‘Play’ button (110, FIG. 18) on the game cabinet or touchscreen display, and serves to place the wager and start a single round of game play in the base game. The base game round includes randomly selecting symbols to populate a matrix of symbol locations, which may contain winning patterns evaluated in various ways. Preferably simulated reels are used in the base game.

At block 1206, the process checks for the presence of a “pick” bonus trigger event in the base game result. Such an event may be a scatter pattern, or the presence of a particular symbol in the base game result, for example. Any suitable triggering event may be used. If no pick bonus trigger is present, the process goes to block 1607 where it evaluates the base game result and conducts any other bonus features that may be present.

If a pick bonus trigger is present at block 1606, the process goes to block 1608 where in a first display area a prize board including a number of symbol locations containing respective symbols indicating respective prize levels and a current position indicator indicating a current location among the symbol locations, and displays in a second display area a number of selectable items. For example, such a state is shown in FIG. 1. Current position indicator 60 begins the bonus game in a central symbol location in this example.

Next, at block 1610, the process begins allowing a player to make selections from the number of selectable items. Responsive to a player selection of a one of the selectable items, the process revealing one of a movement indicator with an associated movement direction, or a prize collector indicator. An example of a movement indicator being selected is depicted in FIG. 2, where the player has selected the selectable item in the upper left of second display area 58, revealing a movement indicator 65 which in this example is an arrow. The indicators revealed by the player selectable outcomes are preferably randomly distributed in second display area 68 (i.e., “true pick”), or provided as a sequence based on a randomly selected outcome (i.e. “prize first”).

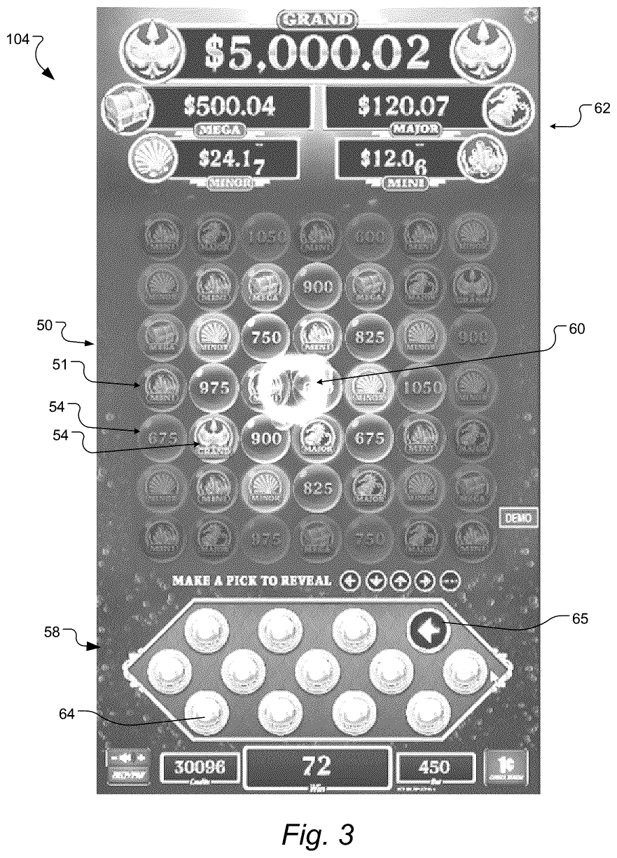

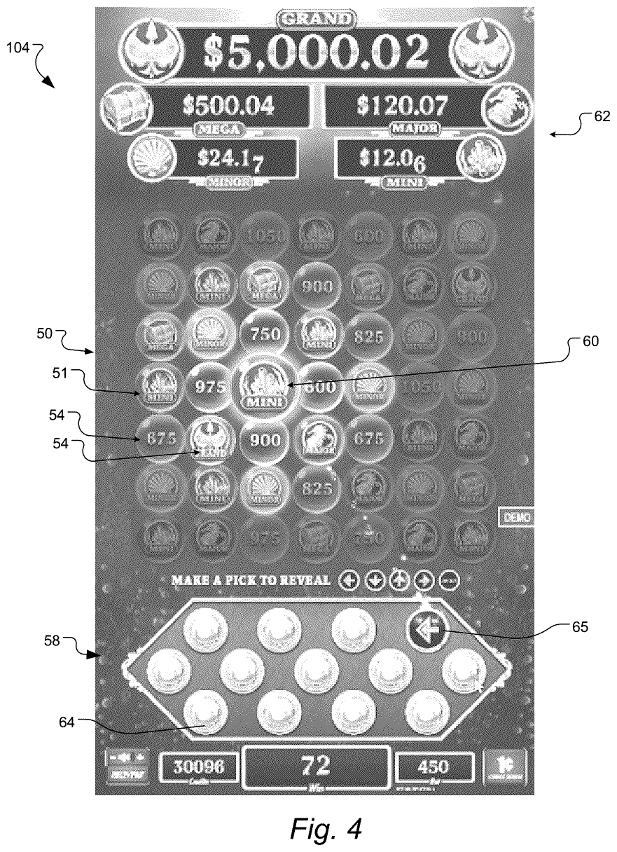

Next at block 1612, the process determines if a movement indicator or a “collect” indicator has been revealed the player pick. Responsive to revealing a movement indicator, the process goes to block 1614, where it causes the current position indicator in the game board to move to an adjacent one of the symbols on the prize board in a direction shown by the movement indicator. An example of this is depicted in the sequence of FIG. 2 through FIG. 4. In FIG. 2, the symbol at current location indicator 60 is shown being animated with an arrow indicating the direction of movement. In this example, the arrow is animated to be superimposed above the symbol. A graphic animation is then shown to depict the movement on game board 51, which is illustrated in progress in FIG. 3, where current position indicator 60 is depicted in progress moving left from its location in FIG. 2. Current position indicator 60 moves one position in the indicated direction to a new symbol location 54, as shown in FIG. 4 where current position indicator is depicted to arrive at a symbol location 54 with a “MINI” prize symbol.

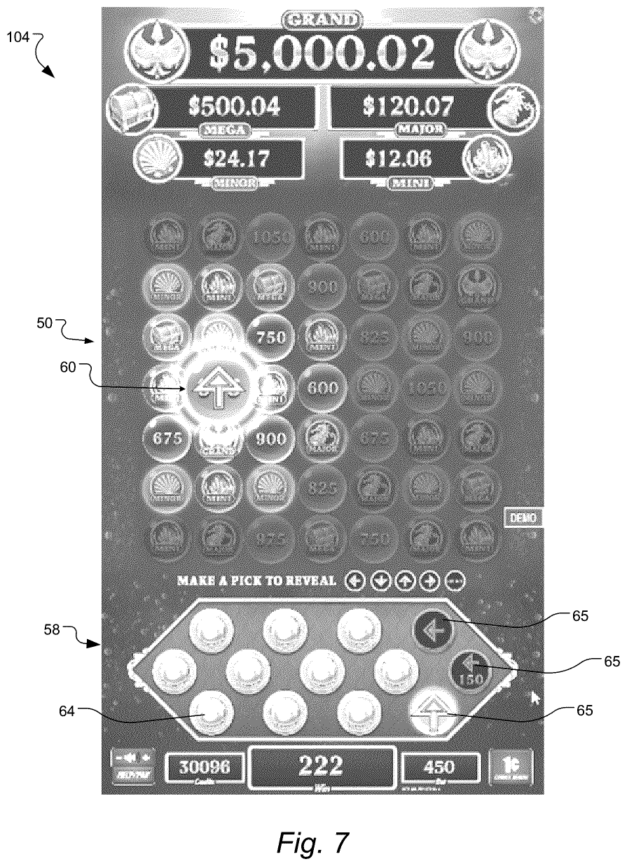

At block 1616, the process enlarges the symbol at the new symbol location after the movement of block 1614. This enlargement preferably occurs during the animation of the movement to draw attention to the movement and emphasize the symbol at the new current location. An example of such enlargement is shown in FIG. 7, where current portion indicator 60 is shown on a symbol location with a “975” prize symbol.

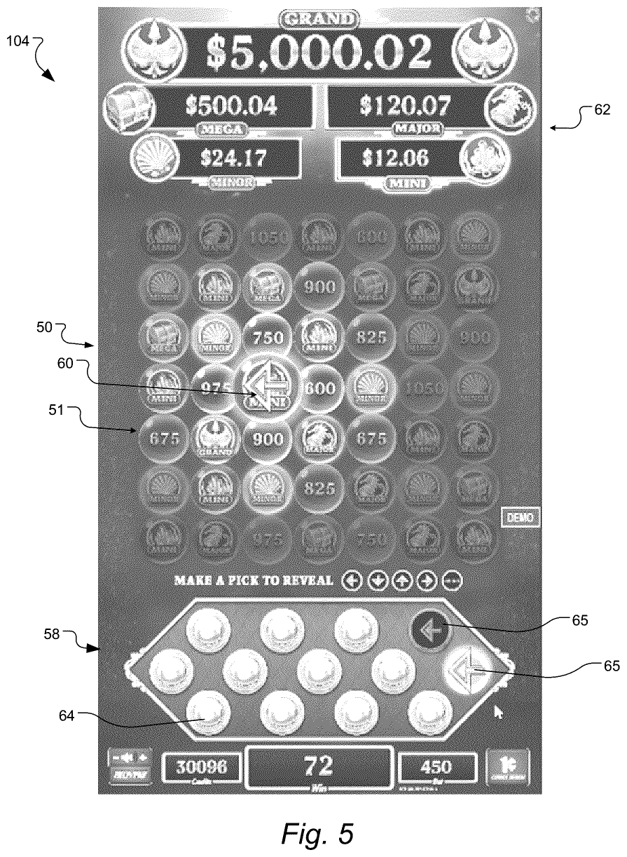

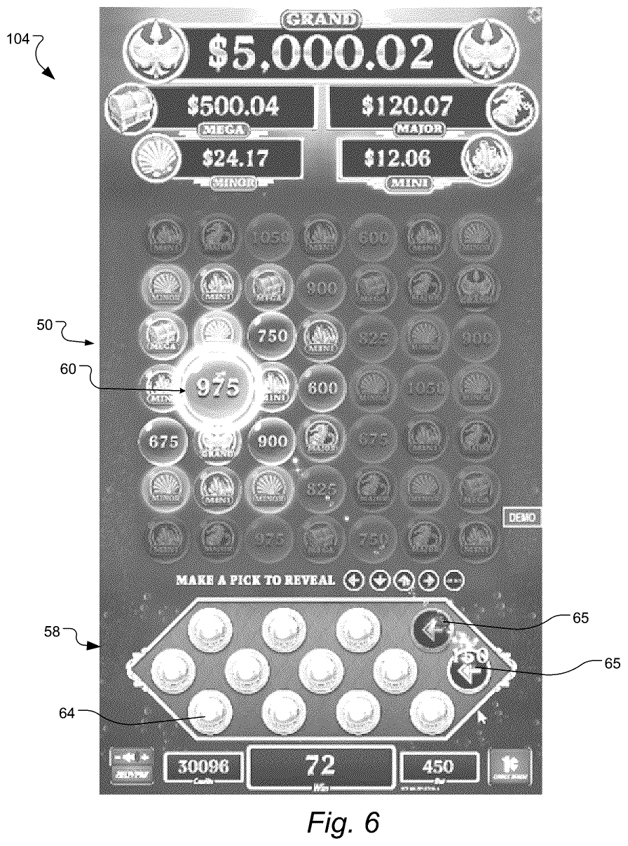

From block 1616, the process returns to block 1610 where the player is allowed to make another pick. FIG. 5 through FIG. 15 illustrate further progress of this example sequence with the player making several more picks of selectable items 64. In FIG. 5, a second pick reveals another movement indicator 65 with a left arrow. The resulting movement animation is shown in game board 51 with current position indicator 60 shown animated to be superimposed above the current symbol location 54 and beginning movement. FIG. 6 shows the game board state after the movement begun in FIG. 5, with current location indicator 60 shown at a symbol location left of the previous location and containing an enlarged “975” symbol.

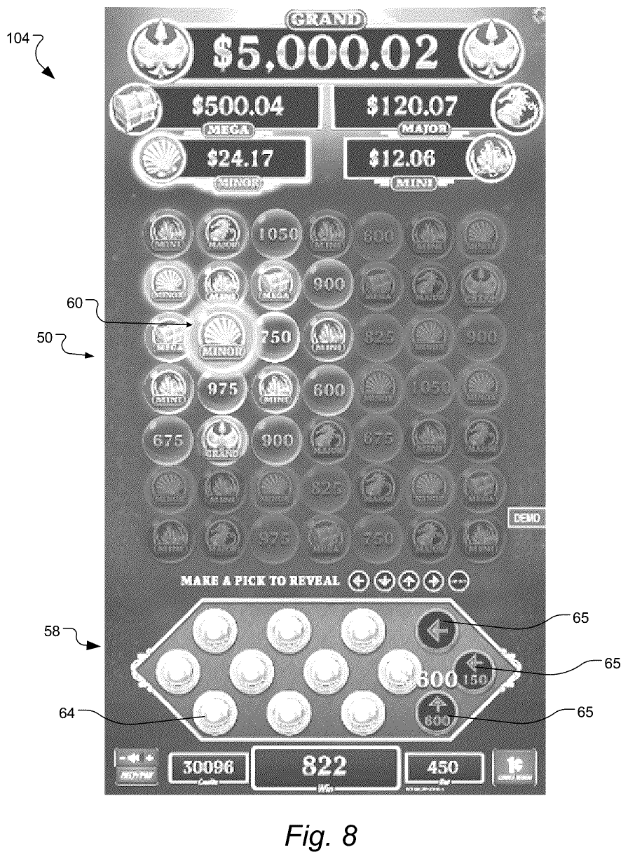

FIG. 7 shows the results of a third player pick, which reveals another movement indicator 65 with an up arrow. The resulting movement animation is shown in game board 51 with current position indicator 60 shown animated to be superimposed above the current symbol location 54 and beginning movement. FIG. 8 shows the game board state after the movement begun in FIG. 7, with current location indicator 60 shown at a symbol location upwards of the previous location and containing an enlarged “MINOR” symbol.

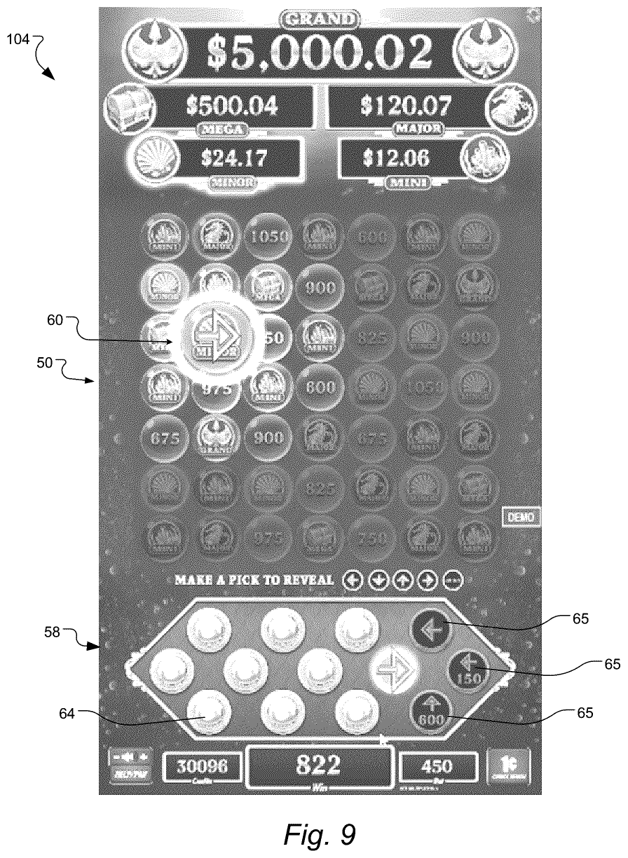

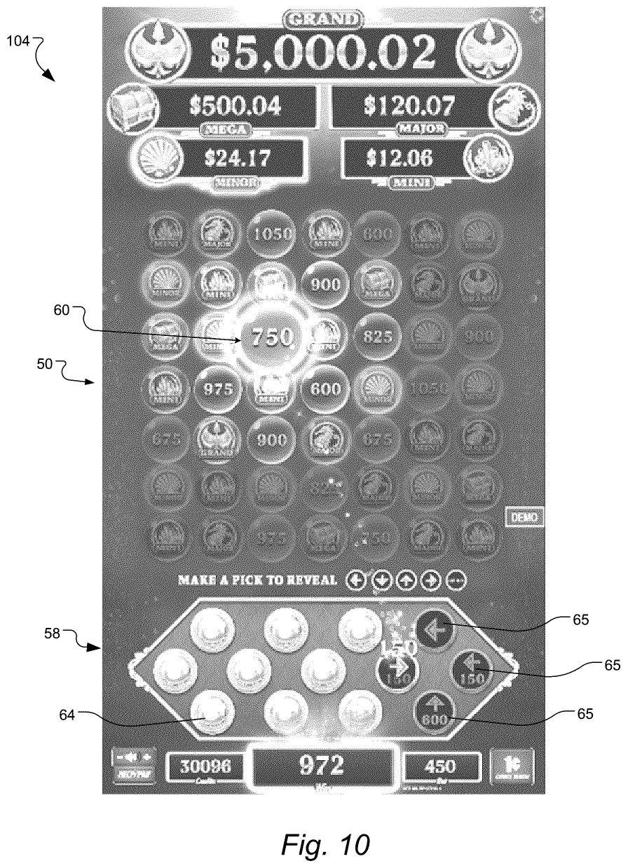

FIG. 9 shows the results of a fourth player pick, which reveals another movement indicator 65 with a right arrow. The resulting movement animation is shown in game board 51 with current position indicator 60 shown animated to be superimposed above the current symbol location 54 and beginning movement. FIG. 10 shows the game board state after the movement begun in FIG. 8, with current location indicator 60 shown at a symbol location upwards of the previous location and containing an enlarged “750” symbol.

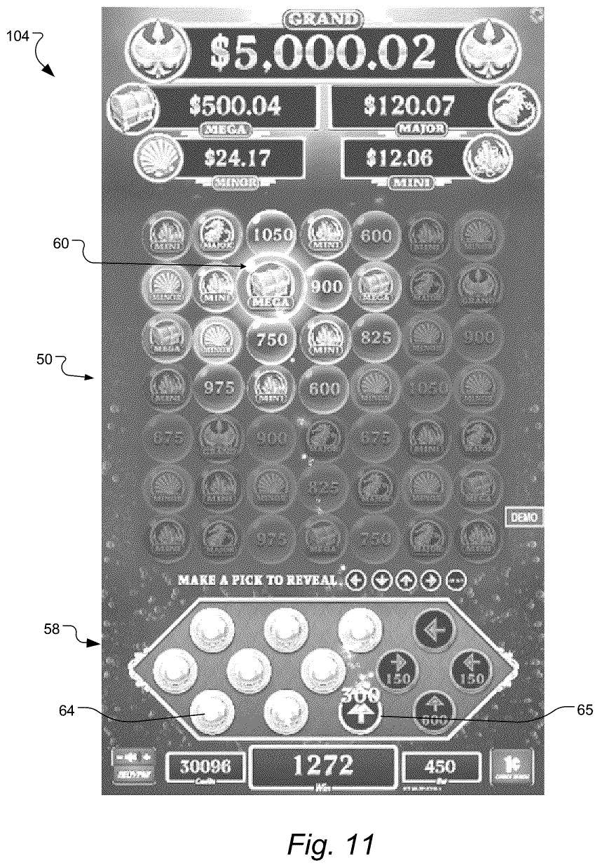

FIG. 11 shows the results of a fifth player pick, after current location indictor 60 has moved. An up arrow movement indictor 65 was revealed by the pick and caused the current location indicator to move up from its location in FIG. 10 to a symbol location with a “MEGA” prize indicator, shown enlarged in FIG. 11.

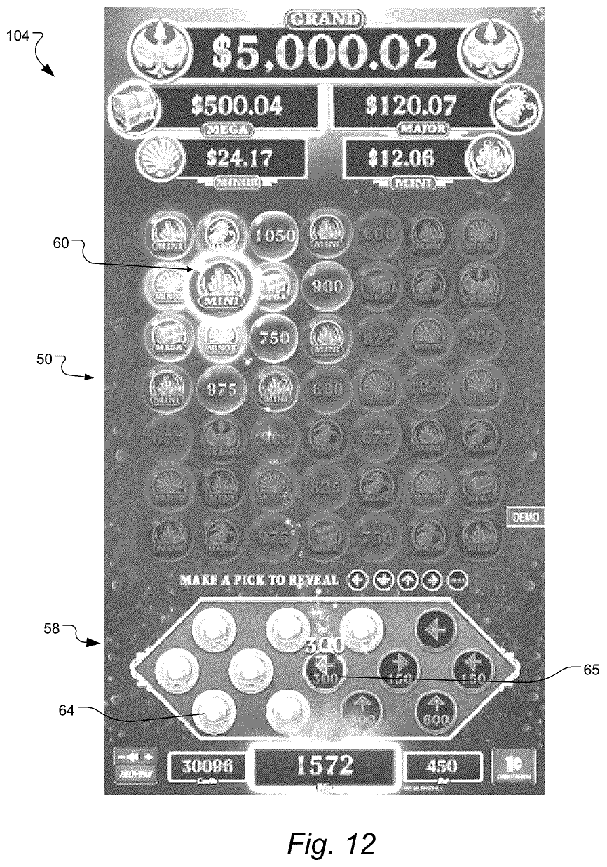

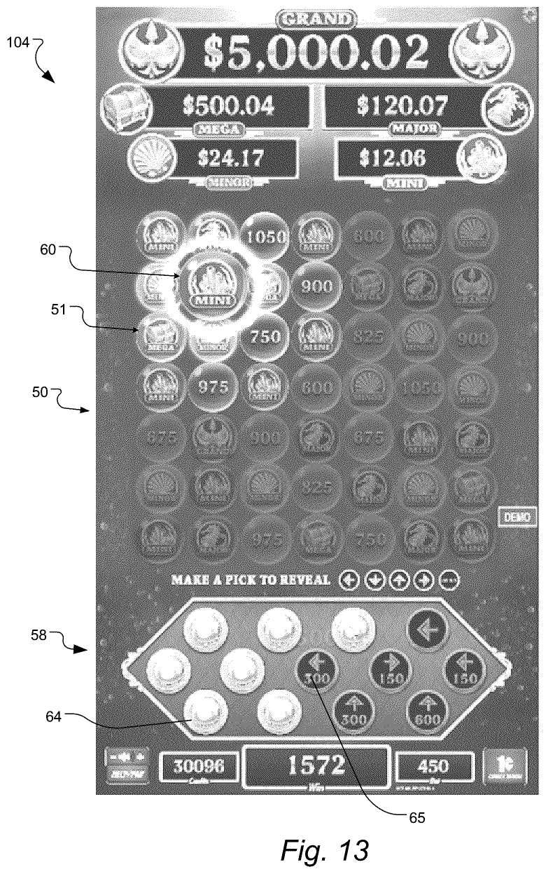

FIG. 12 shows the results of a sixth player pick, after current location indictor 60 has moved. A left arrow movement indictor 65 was revealed and caused the current location indicator to move left from its location in FIG. 11 to the symbol location with the “MINI” prize indicator. FIG. 13 shows a subsequent view in the animation of game board 51, in which not only is the new symbol location at which the current location indicator is positioned enlarged, but is made visually brighter. The surrounding symbol locations are also made brighter as can be seen, while other symbol locations further away are made dimmer.

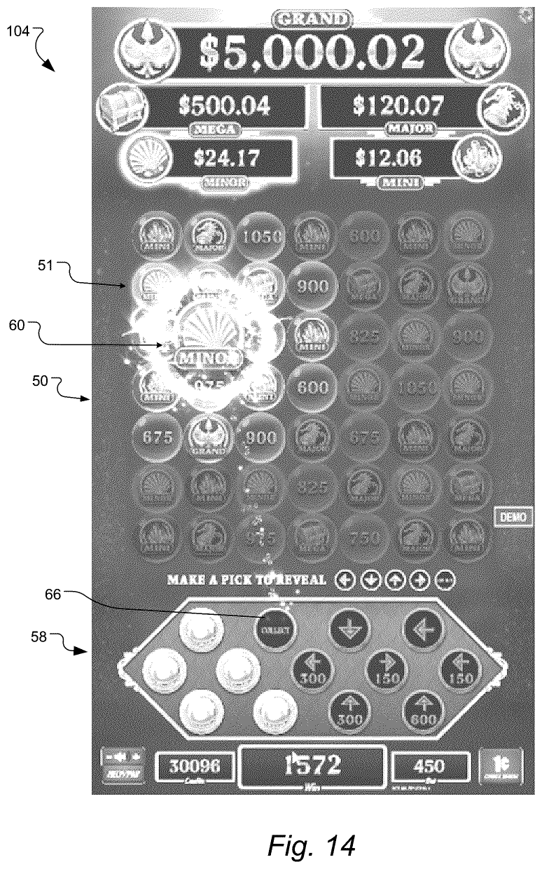

Referring again to FIG. 16, after a pick resulting in a “COLLECT” outcome, the process at block 1612 goes to block 1613 where it awards the prize at the current position indicator. If the current position indicator is at a location with a jackpot prize symbol, such as in the example scenario of FIG. 14, the jackpot prize is awarded. If the current position indicator is at a location with a numerical prize indicator, that prize is awarded. FIG. 14 shows the result after two more player picks, where a COLLECT indicator 66 is revealed by a player pick. A seventh player pick in this example scenario revealed a movement indicator with a down arrow, moving the current position indicator to the symbol location with the “MINOR” symbol associated with the MINOR jackpot award. Then an eighth player pick revealed a COLLECT indicator 66, resulting in the MINOR jackpot being awarded. As depicted in FIG. 14, the award process in this embodiment includes displaying an animation sequence visually connecting COLLECT indicator 66 with current location indicator 60, in this example by a trail of sparkles.

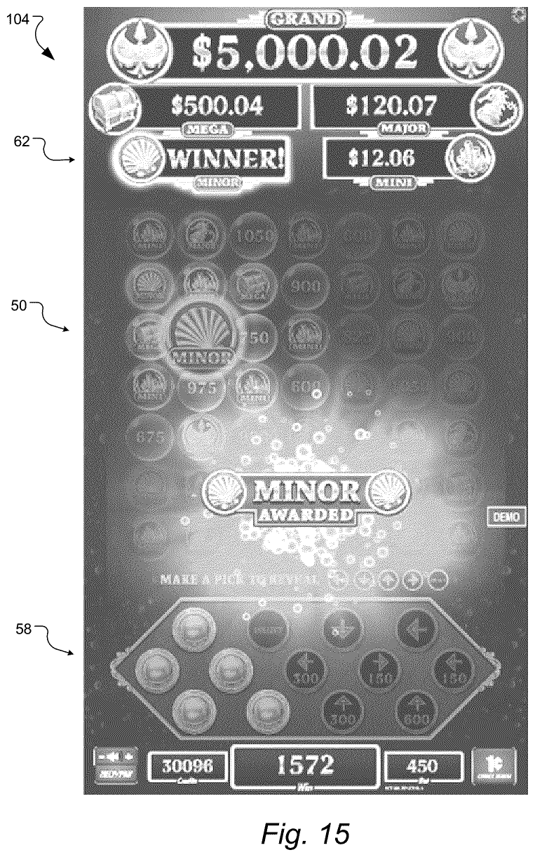

FIG. 15 shows an animation depicting the award of the MINOR jackpot in progress. The contents of first display are 50 and second display area 48 are dimmed as a bright animation resulting from the award is shown, and the MINOR jackpot indicator 62 is highlighted to indicate it is being awarded.

While this particular example sequence with eight player picks was shown to illustrate an example scenario for a movement board game, in various scenarios the process will provide other numbers of picks before a COLLECT indicator is revealed.

In this embodiment, the movement indicators available to be revealed include left, right, up and down movement indicators, as illustrated by the instructions above second display area 58. In some embodiments, diagonal movement indicators in four diagonal directions may be used. Other movement indicators such as moving two or three locations in an indicated direction may also be used. In some embodiments, a movement indicator may be allowed to causes movement off of an edge of game board 54, which causes the current location to move to the opposing edge. In other embodiments, movement indicators which would causes movement off of the edge are not allowed to result from player selections.

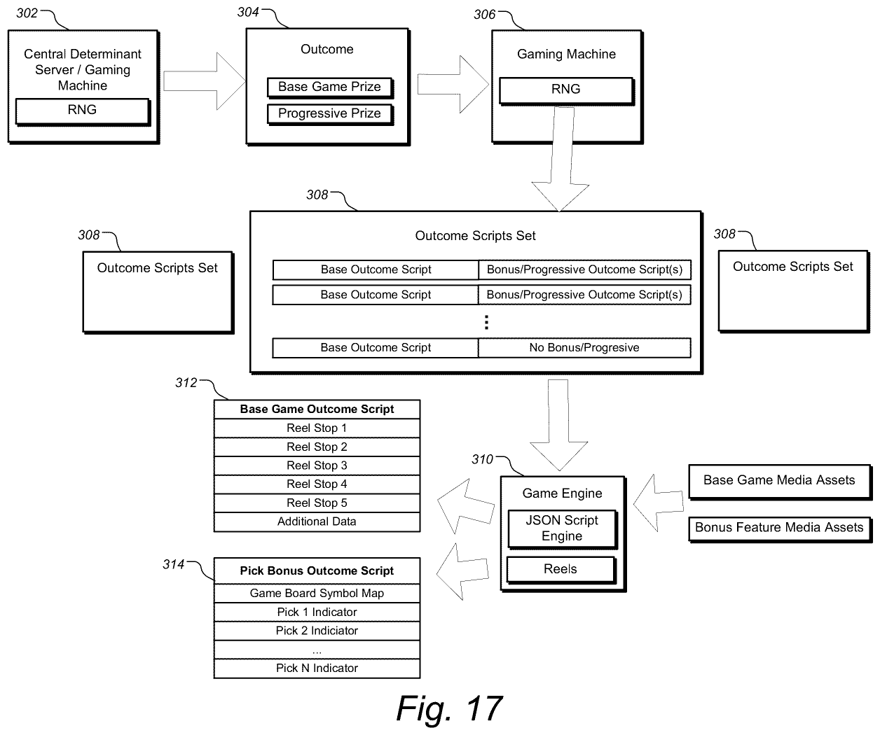

FIG. 17 shows a block diagram of software and data structures performing operations employed in operating a bonus game according to some embodiments. In response to a wager activation or game activation (for example, FIG. 12, block 1204), at block 302 a random number generation is performed, either at central determinant server or the gaming machine. For centralized gaming architectures such as class II type games or lotto-based games, the central determinant server performs this step. For class III type games, typically an RNG on the gaming machines performs this step. The RNG may be a hardware-based RNG conforming to local regulations for both security and random distribution of outcomes.

At block 304, the random number is employed to select an outcome. Typically the outcome is by using the random number to index or access a pool of outcomes having a distribution of prizes which correlates to the desired game math characteristics for the game, including prize distribution and payout percentages. The selected outcome has a possibility of including only a base game prize and a possibility of including a base game prize and a bonus prize or progressive prize provided by a bonus feature or bonus game presentation of various types. In some of these selected outcomes, a movement game board pick bonus such as that described above is included. The typically outcome includes the prize amount for the base game outcome, which may be zero, and the prize amount for the bonus/progressive game outcome, which may be zero.

As shown at block 306, the gaming machine next employs this outcome to operate the game and provide a result. If a central determinant server is used, the outcome is passed to the gaming machine at block 306. If a local RNG is used to select an outcome, the gaming machine is in possession of the outcome. As depicted by the arrow from block 306, the gaming machine uses the prize amount selects a set of outcome scripts 308 from among a group of such sets, each group containing outcome scripts for operating the gaming machine to provide a particular prize amount. The selected set 308 includes multiple scripts which are executable to operate the gaming machine to provide the prize amounts in the outcome in various forms. For example, if the outcome is a base game prize of 200 credits, and no bonus prize, the selected set 308 contains a set of scripts for operating the gaming machine to provide 200 credits through a base game outcome. If the outcome is a base game prize of 100 credits and a bonus game prize of 200 credits, the selected set 308 contains a set of scripts for operating the gaming machine to provide this combination of prizes, each script including base game scripting and bonus or progressive game scripting. From this set, the gaming machine RNG is employed to generate a random number which is used to index the set 308 to select one of the scripts for execution. In some embodiments, further variation is provided for the bonus/progressive prize by generating an additional RNG to determine whether to present the bonus/progressive prize as a single prize or multiple prizes. The selected script may include a base game script and a bonus game script, or only a base game script, as shown by the depicted outcome including a base outcome script and “No Bonus/Progressive”.

As shown at block 310, the selected script is then loaded to a game engine to operate the gaming machine to provide the outcome. In a preferred embodiment, a JSON script engine is employed to execute the script. The JSON script engine accesses media assets from the game module such as base game media assets and bonus/progressive feature media assets contained in data structures 230 and 232 (FIG. 17). It executes the base game outcome script using data structures for simulated reels, typically using a set of reel stops provided in the script to implement the base game prize amount.

As shown in base game outcome script 312, a base game outcome script includes reel stops for each reel, and may include additional data used in presenting the base game result. For results including a movement game board pick bonus, the triggering pattern for such a bonus is present at the reel stops provided.

When movement game board pick bonus is included, the process uses a pick bonus outcome script 314. The script includes a game board symbol map specifying the symbols on game board 51. The script also includes a series of pick indicators specifying which directional indicators are revealed when a player makes a selection, and at which selection a collect type indicator is revealed. The size of this script may vary depending on the number of picks in a particular scripted outcome. This data is used by the game engine to control presentation and flow of the movement type board game, for example as shown in the embodiments described with respect to FIG. 1 through FIG. 16. Additional data may be included, such as extra credit prizes resulting directly from individual picks, for example the “150” prize shown awarded in FIG. 6.

Media assets such as bonus celebration and audio assets are also accessed in presenting the bonus/progressive prize after the bonus/progressive outcome script operates the gaming machine to implement the bonus/progressive sequence as described above.

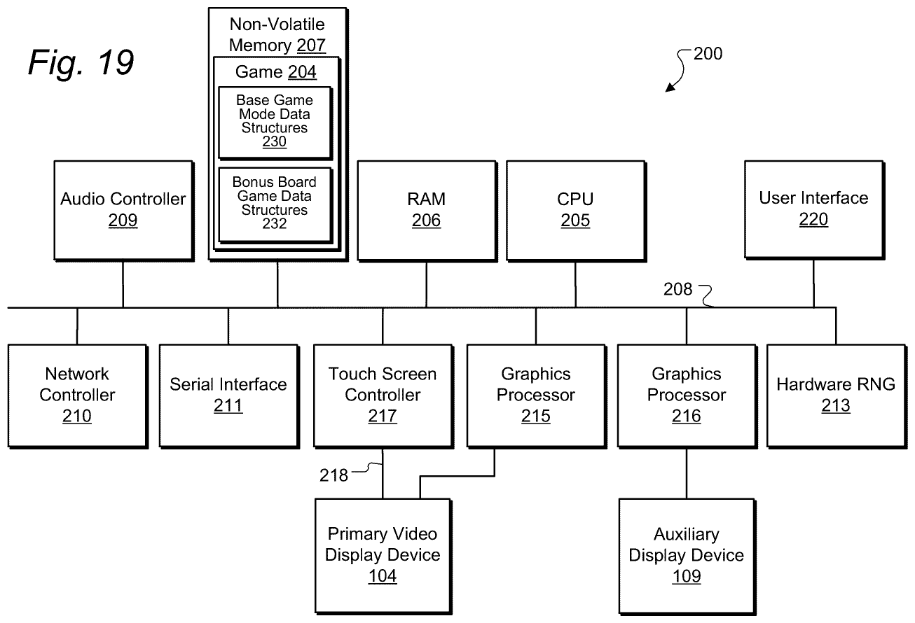

FIG. 18 shows a gaming machine 100 that may be used to implement feature games according to the present invention. The block diagram of FIG. 19 shows further details of gaming machine 100. Referring to FIG. 18, gaming machine 100 includes a cabinet 101 having a front side generally shown at reference numeral 102. Gaming machine 100 includes a display system including one or more display devices such as video displays or mechanical display devices such as spinnable reels or wheels. In the depicted version, the display system includes a primary video display device 104 which is mounted in a central portion of the front side 102, with a ledge 106 positioned below the primary video display device and projecting forwardly from the plane of the primary video display device. Gaming machine 100 also includes two additional smaller auxiliary display devices, and a lower auxiliary display device 109. All of the displays may include touchscreen sensors, especially auxiliary display device 109 which may be used to present touchscreen controls for wagering. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 18 also includes a number of mechanical control buttons 110 mounted on ledge 106. These control buttons 110 may allow a player to select a bet level, select paylines, select a type of game or game feature, and activate a play in the primary game. Further, primary video display device 104 in gaming machine 100 provides a convenient display device for implementing touchscreen controls.

Gaming machine 100 may also include a number of other player interface devices in addition to devices that are considered player controls for use in playing a particular game. Ledge 106 may also include a hardware special object including a button, touch sensor, or switches, joysticks, or other mechanical input devices, and/or virtual buttons and other controls implemented on a suitable touchscreen video display. Gaming machine 100 also includes a currency/voucher acceptor 112 having an input ramp, a player card reader having a player card input 114, and a voucher/receipt printer having a voucher/receipt output 115. One or more of these devices provides a credit input device in communication with the controller and adapted for accepting a physical item associated with a monetary value that establishes a player credit balance. Audio speakers 116 generate an audio output to enhance the user's playing experience. Numerous other types of devices may be included in gaming machines that may be used according to the present invention.

FIG. 19 shows a hardware and logical block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on system bus 208 and is connected to drive primary video display device 104 (mounted in cabinet 101 as shown in FIG. 18). A second graphics processor 216 is also connected on system bus 208 in this example to drive the auxiliary display device 109 also shown in FIG. 18. Gaming machine 100 also includes a touch screen controller 217 connected to system bus 208. Touch screen controller 217 is also connected via signal path 218 to receive signals from a touchscreen element associated with primary video display device 104. It will be appreciated that the touchscreen element itself typically comprises a thin film that is secured over the display surface of primary video display device 104. The touchscreen element itself is not illustrated or referenced separately in the figures.

Those familiar with data processing devices and systems will appreciate that other common electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 19 are known elements used in the gaming machine industry. These elements are preferably mounted in a computer chassis which is housed in cabinet 101 shown in FIG. 18. Alternatively, the various electronic components may be mounted on one or more circuit boards or modules housed within cabinet 101 without a separate enclosure. Those familiar with data processing systems and the various data processing elements shown in FIG. 19 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 19 as being connected directly on system bus 208 may in fact communicate with the other system components through a suitable expansion bus. Audio controller 209, for example, may be connected to the system via a PCI bus. System bus 208 is shown in FIG. 19 merely to indicate that the various components are connected in some fashion for communication with game processor/CPU 205 and is not intended to limit the invention to any particular bus architecture. Numerous other variations in the gaming machine internal structure and system may be used without departing from the principles of the present invention.

Although separate graphics processor 215 is shown for controlling primary video display device 104, and graphics processor 216 is shown for controlling both auxiliary display device 109, it will be appreciated that game processor/CPU 205 may control all of the display devices directly without any intermediate graphics processor. The invention is not limited to any particular arrangement of processing devices for controlling the video display device included with gaming machine 100. Also, a gaming machine implementing the present invention is not limited to any particular number of video display devices or other types of display devices.

In the illustrated gaming machine 100, game processor/CPU 205 executes software which ultimately controls the entire gaming machine including the receipt of player inputs and the presentation of the graphic symbols displayed, and the cascade and mystery symbol indicator feature according to the invention through the display devices 104 and 109 associated with the gaming machine. As will be discussed further below, game processor/CPU 205 either alone or in combination with graphics processor 215 may implement a presentation controller for performing functions associated with a primary game that may be available through the gaming machine, and may also implement a game client for directing one or more display devices at the gaming machine to display the feature game mode according to the present invention. Game processor/CPU 205 also executes software related to communications handled through network controller 210, and software related to various peripheral devices such as those connected to the system through audio controller 209, serial interface 211, and touch screen controller 217. Game processor/CPU 205 may also execute software to perform accounting functions associated with game play. Random access memory 206 provides memory for use by game processor/CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included.

It should be noted that the invention is not limited to gaming machines employing the arrangement of processing devices and interfaces shown in example gaming machine 100. Other gaming machines through which the features herein are implemented may include one or more special purpose processing devices to perform the various processing steps for implementing the present invention, such as generating random numbers or checking the security status of software packages or gaming credit vouchers. Unlike processing devices such as game processor/CPU 205, these special purpose processing devices may not employ operational program code to direct the various processing steps.

Still referring to the hardware and logical block diagram 200 showing an example design for a gaming machine 100, the depicted machine in operation is controlled generally by game processor/CPU 205 which stores operating programs and data in non-volatile memory or storage device 207 with game module 204, and software or drivers for user interface 220, network controller 210, audio/visual controllers, and a hardware random number generator (RNG) 213, which is employed if software RNG procedures are not allowed in a particular gaming jurisdiction. Either hardware RNG 213 or a suitable software RNG are employed for making the random selections of game outcomes, reel stop positions, etc. when operating the game as described herein. The game module 204, once installed, also is held in non-volatile memory of the EGM, preferably a separate flash drive or hard drive from the memory holding the EGM operating system. CPU or game processor/CPU 205 may comprise a conventional microprocessor, such as an Intel microprocessor, mounted on a printed circuit board with supporting ports, drivers, memory, software, and firmware to communicate with and control gaming machine operations, such as through the execution of coding stored in non-volatile memory or storage device 207 including one or primary game modules 202, including executable code and data structures such as data structures 230 for performing the primary or base game mode, and data structures 232 for providing the movement board game and their graphic sequences as described above. Game processor/CPU 205 connects to user interface 220 such that a player may enter input information, and game processor/CPU 205 may respond according to its programming, such as to apply a wager and initiate execution of a game.

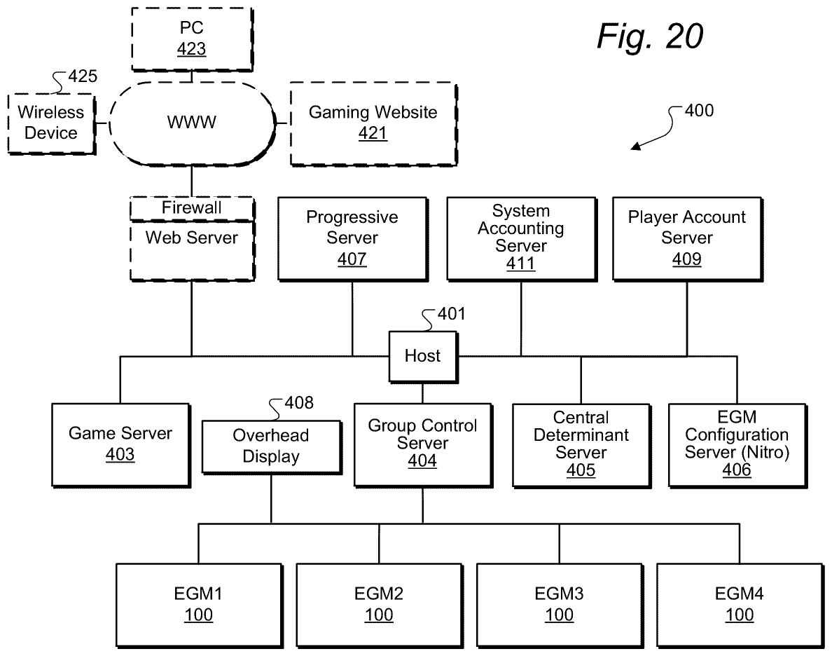

Game processor/CPU 205 also may connect through network controller 210 to a gaming network, such as example casino server network 400 shown in FIG. 20.

Referring now to FIG. 20, the casino server network 400 may be implemented over one or more site locations and include host server 401, and an EGM configuration server 406 (in the preferred version the Even Games Nitro Host server) for managing the configuration of multiple EGMs 100 on the network. A group display device 408 is coupled to casino server network 400 may include its own controller and graphics processor for driving the group display in response to commands received over a network connection. The network may also include remote game play server 403 (which may be configured to provide game processor functionality including determining game outcomes and providing audio/visual instructions to a remote gaming device), a group control server 404, central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards. While some of the servers have been shown separately, they may be combined or split into additional servers having additional capabilities.

As shown, networked electronic gaming machines 100 (EGM1-EGM4) and one or more overhead group displays 408 may be network connected and enable the content of one or more displays of gaming machines 100 to be mirrored or replayed on an overhead display. EGMs 100 may also feed celebration graphics directly to the overhead displays 408 in the course of providing games, for example to show a celebration for a large bonus win or group gaming mode win on a particular EGM 100. Typically the overhead display function and group celebration scenarios are managed by a floor messaging server such as Nitro floor messaging server 404, which receives messages from EGM's 100 to communicate group gaming mode wins, bonus game wins, or awards of other large prizes such as progressive prizes. The primary display content may also be stored by the display controller or game processor/CPU 205 and transmitted through network controller 210 to the overhead display controller either substantially simultaneously or at a subsequent time according to either periodic programming executed by game processor/CPU 205 or a triggering event, such as a jackpot or large win, at a respective gaming machine 100. In the event that gaming machines 100 have cameras installed, the respective player's video images may be displayed on overhead display 408 along with the content of the player's gaming machine 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e. g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor/CPU 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Apple iPhone, Android phone, tablet, phablet, virtual reality device, iPad, etc.). To enter the website, a player may log in with a username (that may be associated with the player's account information stored on player account server 409 or be accessible by a casino operator to obtain player data and provide promotional offers), play various games on the website, make various personalizing selections and save the information, so that during a next gaming session at a casino establishment, the player's playing data and personalized information may be associated with the player's account and accessible at the player's selected gaming machine 100.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method for controlling operation of a gaming machine, the method including:
responsive to a play input entered through a player input device of the gaming machine and under control of a processing system of the gaming machine, causing a display system of the gaming machine to display a base result representation comprising a matrix of symbols including multiple columns and rows;
responsive to a trigger pattern formed in the base result representation, causing the display system to display in a first display area a prize board including a number of symbol locations containing respective symbols indicating respective prize levels and a current position indicator indicating a current location among the symbol locations, and display in a second display area a number of selectable items;
allowing a player to make selections from the number of selectable items;
responsive to a player selection of a one of the selectable items, revealing one of a movement indicator with an associated movement direction, or a prize collector indicator;
responsive to revealing a movement indicator, causing the current position indicator to move to an adjacent one of the symbols on the prize board in a direction shown by the movement indicator; and
responsive to revealing a prize collector indicator, awarding a prize associated with the prize level of the current position indicator.

2. The method of claim 1 further comprising, responsive to revealing a movement indicator, enlarging the adjacent symbol to which the current position indicator is moved.

3. The method of claim 2 further comprising, responsive to revealing a movement indicator, increasing a visual brightness of the adjacent symbol to which the current position indicator is moved and a group of the symbols surrounding the adjacent symbol to which the current position indicator is moved.

4. The method of claim 1 wherein the symbols include a set of jackpot award symbols associated with a set of respective jackpot awards, and a set of numerical symbols associated with respective prize values.

5. A gaming machine comprising:
a display system, an audio device, a player input device, and a processing system operatively coupled to the display system, the audio device, and the player input device and configured to execute instructions related to a game; and
tangible, non-transitory electronically accessible memory coupled to the processing system and containing program code executable by the processing system for:
responsive to a play input entered through the player input device, causing the display system to display a base result representation comprising a matrix of symbols including multiple columns and rows;
responsive to a trigger pattern formed in the base result representation, causing the display system to display in a first display area a prize board including a number of symbol locations containing respective symbols indicating respective prize levels and a current position indicator indicating a current location among the symbol locations, and display in a second display area a number of selectable items;
allowing a player to make selections from the number of selectable items;
responsive to a player selection of a one of the selectable items, revealing one of a movement indicator with an associated movement direction, or a prize collector indicator;
responsive to revealing a movement indicator, causing the current position indicator to move to an adjacent one of the symbols on the prize board in a direction shown by the movement indicator; and
responsive to revealing a prize collector indicator, awarding a prize associated with the prize level of the current position indicator.

6. The gaming machine of claim 5 wherein the program code is further executable for, responsive to revealing a movement indicator, enlarging the adjacent symbol to which the current position indicator is moved.

7. The gaming machine of claim 6 wherein the program code is further executable for, responsive to revealing a movement indicator, increasing a visual brightness of the adjacent symbol to which the current position indicator is moved and a group of the symbols surrounding the adjacent symbol to which the current position indicator is moved.

8. The gaming machine of claim 7 wherein the symbols include a set of jackpot award symbols associated with a set of respective jackpot awards, and a set of numerical symbols associated with respective prize values.

9. Tangible, non-transitory computer readable media holding a program product for execution by a processing system of a gaming machine, the program product including machine instruction program code for:
responsive to a play input entered through a player input device of the gaming machine, causing a display system of the gaming machine to display a base result representation comprising a matrix of symbol including multiple columns and rows;
responsive to a trigger pattern formed in the base result representation, causing the display system to display in a first display area a prize board including a number of symbol locations containing respective symbols indicating respective prize levels and a current position indicator indicating a current location among the symbol locations, and display in a second display area a number of selectable items;
allowing a player to make selections from the number of selectable items;
responsive to a player selection of a one of the selectable items, revealing one of a movement indicator with an associated movement direction, or a prize collector indicator;
responsive to revealing a movement indicator, causing the current position indicator to move to an adjacent one of the symbols on the prize board in a direction shown by the movement indicator; and
responsive to revealing a prize collector indicator, awarding a prize associated with the prize level of the current position indicator.

10. The media holding a program product of claim 9 wherein the program code is further executable for, responsive to revealing a movement indicator, enlarging the adjacent symbol to which the current position indicator is moved.

11. The media holding a program product of claim 10 wherein the program code is further executable for, responsive to revealing a movement indicator, increasing a visual brightness of the adjacent symbol to which the current position indicator is moved and a group of the symbols surrounding the adjacent symbol to which the current position indicator is moved.

12. The media holding a program product of claim 9 wherein the symbols include a set of jackpot award symbols associated with a set of respective jackpot awards, and a set of numerical symbols associated with respective prize values.
